(19) United States
(12) Patent Application Publication
(10) Pub. No.: US 2016/0259560 A1
(43) Pub. Date: Sep. 8, 2016

(54) INFORMATION PROCESSING APPARATUS, INFORMATION PROCESSING SYSTEM, AND CONTROL PROGRAM

(71) Applicant: FUJITSU LIMITED, Kawasaki-shi (JP)

(72) Inventor: AKIHIRO UEDA, Kawasaki (JP)

(73) Assignee: FUJITSU LIMITED, Kawasaki-shi (JP)

(21) Appl. No.: 15/018,140

(22) Filed: Feb. 8, 2016

(30) Foreign Application Priority Data
Mar. 3, 2015 (JP) 2015-041061

(51) Int. Cl. G06F 3/06; G06F 9/455

(52) U.S. Cl. CPC G06F 3/065; G06F 3/0619; G06F 3/0659; G06F 3/0683; G06F 9/45558; G06F 2009/45583; G06F 2009/4557

(57) ABSTRACT

An information processing apparatus connected to a second storage device in which volumes in a first storage device are duplicated due to a first duplication processing for duplicating volumes of a source storage device to a duplication target storage device, wherein, the information processing apparatus has a control unit that: transmits, to the second storage device, combination information for indicating a combination of a first volume that is a duplication source and a second volume that is a duplication target when a second duplication processing for duplicating data between volumes in a same storage device is executed by the first storage device; and obtains, from the second storage device, combination information for indicating a combination of a volume in which the data of the first volume is duplicated and a volume in which data of the second volume is duplicated, respectively due to the first duplication processing.

### CROSS-REFERENCE TO RELATED APPLICATION

This application is based upon and claims the benefit of priority of the prior Japanese Patent Application No. 2015-041061, filed on Mar. 3, 2015, the entire contents of which are incorporated herein by reference.

### FIELD

The embodiment discussed herein relates to an information processing apparatus, an information processing system, and a control program.

### BACKGROUND

Conventionally, there is a technique for carrying out a service operation which involves performing remote equivalent copy (REC) for duplicating data in volumes of a storage device at an operations site to a storage device at a disaster measures site and then using the disaster measures site when the operations site is affected by a disaster. Further, there is a technique for performing one point copy (OPC) for copying data from a duplication source volume to a duplication target volume inside a storage device. When the disaster measures site is carrying out the service operation, OPC is taken over by the disaster measures site if the operations site is set to perform OPC.

Moreover, Japanese Laid-open Patent Publication No. 2009-026295 discusses a technique for transferring an association between a virtual port and a physical port created by the physical port to a transfer target server when a failure occurs in the physical port or in a link connected to the physical port as a related prior art. Further, when a failure occurs in a main logical volume, Japanese Laid-open Patent Publication No. 2014-049116 discusses a technique for transferring a virtual machine of a transfer source server to a transfer target server and changing an input/output (I/O) path between the transfer source server and the positive logical volume to a different I/O path between the transfer target server and a subsidiary logical volume.

However, according to the abovementioned prior art, there is a problem in specifying a combination of volumes corresponding to the duplication source volume and the duplication target volume during OPC at the operations site from the plurality of volumes of the storage device in the disaster measures site when OPC is taken over at the disaster measures site. Specifically, an administrator of the disaster measures site examines the REC setting contents and the OPC setting contents at the operations site and compares the two setting contents, and a certain amount of time is desired to specify the OPC setting contents at the disaster measures site.

An object of one aspect of the embodiment discussed herein is to provide an information processing apparatus, an information processing system, and a control program that are able to easily specify a combination of volumes corresponding to a combination of a duplication source volume and a duplication target volume for duplicating data in a duplication source storage device, from a plurality of volumes in a duplication target storage device.

### SUMMARY

According to an aspect of the invention, an information processing apparatus connected to a second storage device in which volumes in a first storage device are duplicated due to a first duplication processing for duplicating volumes of a source storage device to a duplication target storage device, wherein, the information processing apparatus has a control unit that: transmits, to the second storage device, combination information for indicating a combination of a first volume that is a duplication source and a second volume that is a duplication target when a second duplication processing for duplicating data between volumes in a same storage device is executed by the first storage device; and obtains, from the second storage device, combination information for indicating a combination of a volume in which the data of the first volume is duplicated and a volume in which data of the second volume is duplicated, respectively due to the first duplication processing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a view (one of two) for explaining an example of operations by an information processing system according to the present embodiment;

FIG. 1B is a view (two of two) for explaining an example of operations by an information processing system according to the present embodiment;

FIG. 2 is a block diagram of a hardware configuration of an information processing apparatus;

FIG. 3 is a block diagram of a hardware configuration of storage devices;

FIG. 4 is a block diagram of a functional configuration of the information processing apparatus;

FIG. 5 is a block diagram of a functional configuration of the storage devices;

FIG. 6 is a view for explaining an example of stored contents of copy setting information;

FIG. 7 is a view for explaining an example of a conversion of copy pair information;

FIG. 8 is a flow chart for illustrating an example of copy pair information converting procedures after a site switch; and

FIG. 9 is a flowchart of an example of LUN conversion procedures.

### DESCRIPTION OF EMBODIMENT

Detailed embodiments of the information processing apparatus, the information processing system, and the control program disclosed will be discussed hereinbelow with reference to the drawings.

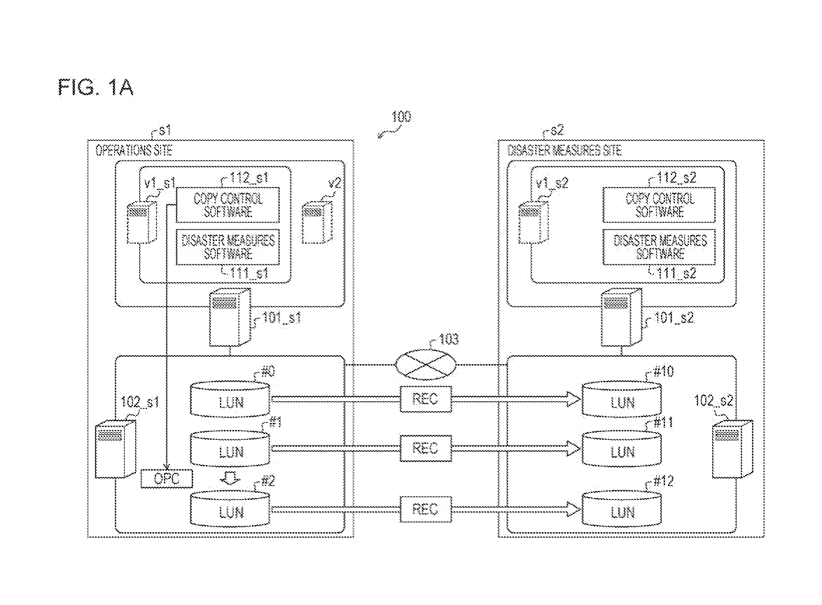

FIG. 1A is a view (one of two) for explaining an example of operations by an information processing system 100 according to the present embodiment. FIG. 1B is a view (two of two) for explaining an example of operations by the information processing system 100 according to the present embodiment. The information processing system 100 includes an operations site s1 and a disaster measures site s2 that acts as disaster measures for the operations site s1. The operations site s1 and the disaster measures site s2 are connected to a network 103 such as a wide area network (WAN). A site herein is a collection of servers and the like that provide information.

The operations site s1 is a site for providing a business service. The disaster measures site s2 is a site for providing the business service in place of the operations site s1 when the operations site s1 is affected by a disaster. Therefore, the disaster measures site s2 is preferably installed in a location remote from the operations site s1 so as not to be affected by the same disaster that affects the operations site s1.

The operations site s1 has an information processing apparatus 101_s1 and a storage device 102_s1 as a first storage device. The disaster measures site s2 has an information processing apparatus 101_s2 and a storage device 102_s2 as a second storage device. The attached reference numeral “s1” pertains to the operations site s1. The attached reference numeral “s2” pertains to the disaster measures site s2.

FIG. 1A depicts the operations of the information processing system 100 during normal operations. FIG. 1B depicts operations of the information processing system 100 when a disaster occurs at the operations site s1.

The storage devices 102_s1 and s2 each have a plurality of volumes. Each of the volumes among the plurality of volumes has a logical unit number (LUN) attached thereto. In order to facilitate the following explanation, a volume having a LUN#x attached thereto is simply described as “LUN#x”. “x” is an integer equal to or greater than zero. The term “LUN” may be omitted and depicted simply as “#x” in FIGS. 1A to 9.

The storage device 102_s1 in the examples in FIGS. 1A and 1B has LUN#0 to LUN#2. The storage device 102_s2 in the examples in FIGS. 1A and 1B has LUN#10 to LUN#12.

The information processing apparatuses 101_s1 and s2 are both computers for controlling the respective storage devices 102_s1 and s2. Specifically, the information processing apparatus 101_s1 is connected in an accessible manner to the storage device 102_s1. Similarly, the information processing apparatus 101_s2 is connected in an accessible manner to the storage device 102_s2. The information processing apparatus 101_s2 is a server for example. The information processing apparatus 101_s1 implements virtual servers v1_s1 and v2 which are virtual machines treated as servers by using software for implementing a server virtualization environment. The information processing apparatus 101_s2 implements a virtual server v1_s2 which is a virtual machine treated as a server using the software for implementing the server virtualization environment. While a hypervisor type or a host type may be used as methods for implementing the virtualization environment, the method used in the present embodiment may be either method. The virtual servers in FIGS. 1A and 1B are indicated by dotted lines. A virtual machine is software for imitating the operations of a computer.

The virtual servers v1_s1 and s2 both have disaster measures software 111_s1 and s2 which is software for carrying out disaster measures, and copy control software 112_s1 and s2 which is software for controlling copying. The disaster measures software 111_s2 and the copy control software 112_s2 are in a standby state during normal operations.

The virtual server v2 is a server for executing the business service. While not illustrated in FIGS. 1A and 1B, the information processing apparatuses 101_s1 and s2 both execute virtual servers installed with software for running and managing the server virtualization environment.

The disaster measures software 111 instructs a duplication source storage device and a duplication target storage device to execute first duplication processing for duplicating data in each volume of the duplication source storage device to each volume in the duplication target storage device through the copy control software 112. In the example in FIG. 1A, the storage device 102_s1 copies the data of the LUN#0 to the LUN#10, the data of the LUN #1 to the LUN #11, and the data of the LUN#2 to the LUN#12 according to the first duplication processing. Further, the disaster measures software 111_s2 switches the site performing the business service to the disaster measures site s2 by transferring the virtual server v2 when the operations site s1 is affected by a disaster. By transferring the virtual server v2, the information processing system 100 is able to continue the business service due to the disaster measures site s2 having the same data executing the virtual server v2 even when the operations site s1 is affected by a disaster.

The copy control software 112 instructs a certain storage device to perform second duplication processing for duplicating the data between the volumes of the certain storage device. In the example in FIG. 1A, the storage device 102_s1 copies the data in the LUN#1 which acts as a first volume to the LUN#2 which acts as a second volume using OPC as one business service performed by the virtual server v2. By executing the copy control software 112_s1, the operations site s1 is able to manage backup operations. The first duplication processing is referred to below as REC. The second duplication processing is referred to below as OPC. Further, “duplicating” is referred to in the following explanations as “copying” for in order to unify the terminology.

After a disaster has occurred at the operations site s1, the copy control software 112_s2 in the information processing apparatus 101_s2 is executed so as the take over OPC in the same way as during normal operations.

The setting contents of the OPC is converted from contents of the operations site s1 to contents of the disaster measures site s2. However, there is a problem in specifying the combination of volumes corresponding to the duplication source volume and the duplication target volume during OPC of the operations site s1 from the plurality of volumes of the storage device 101_s2 when OPC is taken over at the disaster measures site s2. Specifically, an administrator of the disaster measures site s2 examines the REC setting contents and the OPC setting contents of the operations site s1 and compares the two setting contents, and a certain amount of time is desired to specify the OPC setting contents of the disaster measures site s2. The amount of time desired by the administrator increases in correspondence to an increase in the number of combinations of volumes included in the OPC setting contents of the operations site s1.

Accordingly, the information processing apparatus 101_s2 transfers the volume combinations of the copy source and copy target of OPC in the storage device 102_s1 to the storage device 102_s2, and obtains the volume combinations of the storage device 102_s2 corresponding to the combinations. A combination herein is information indicating a combination of two volumes. As a result, the information processing apparatus 101_s2 is able to use the REC setting contents and easily specify the OPC settings in the storage device 102_s2.

An explanation of operations by the information processing apparatus 101_s2 will be explained using FIG. 1B. As illustrated by (1) in FIG. 1B, the information processing apparatus 101_s2 transfers a combination 121 of a copy source volume and a copy target volume when OPC is executed in the storage device 102_s1, to the storage device 102_s2. The combination 121 is the OPC setting in the storage device 102_s1. At the point in time that the operations site s1 is affected by a disaster, the storage device 102_s1 may have executed OPC any number of times or may have not executed OPC at all. If the storage device 102_s1 has not executed OPC, the storage device 102_s1 may only perform the setting for executing OPC. The combination 121 indicated in FIG. 1B is information which indicates the combination of the LUN#1 as the copy source and the LUN#2 as the copy target. The combination 121 is a combination that is copied from the storage device 102_s1 according to REC and obtained by the information processing apparatus 101_s2.

The storage device 102_s2 that receives the combination 121 refers to information 122 and retrieves a third volume and a fourth volume that copied the data of the duplication source volume and the duplication target volume according to REC from the storage device 102_s2 as illustrated by (2) in FIG. 1B. The contents of the information 122 is the REC setting contents. Specifically, the information 122 indicates the combinations of the volumes of the storage device 102_s1 and the volumes of the storage device 102_s2 in which the data from the volumes of the storage device 102_s1 were copied according to REC.

In the example in FIG. 1B, the information 122 indicates that the data of the LUN#0 is copied to the LUN#10, the data of the LUN #1 is copied to the LUN #11, and the data of the LUN#2 is copied to the LUN#12. The storage device 102_s2 then detects, as the third volume, the LUN#11 into which the data of the LUN#1 that is the duplication source volume is copied. The storage device 102_s2 also detects, as the fourth volume, the LUN#12 into which the data of the LUN#2 that is the duplication source volume is copied.

Next, the storage device 102_s2 transmits a combination 123 of the third volume and the fourth volume to the information processing apparatus 101_s2. In the example in FIG. 1B, the storage device 102_s2 transmits the combination 123 of the detected LUN#11 and the LUN#12 to the information processing apparatus 101_s2.

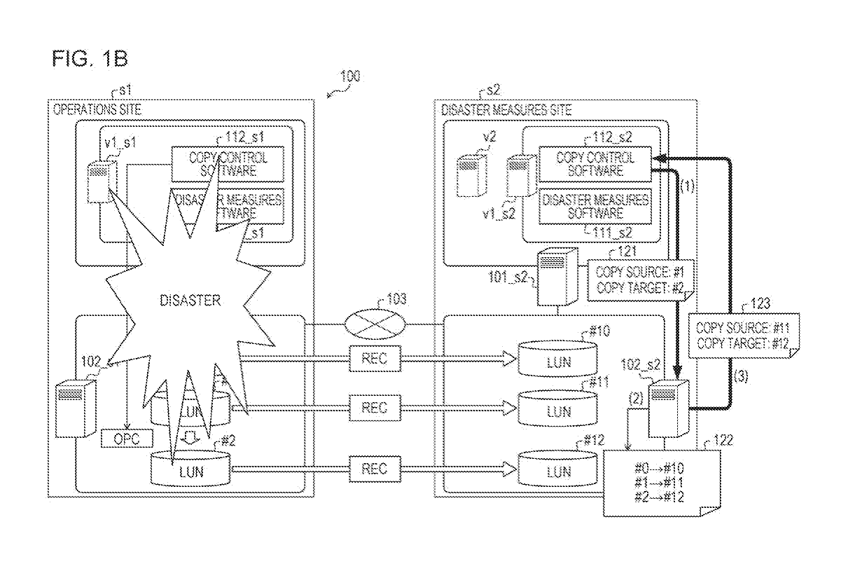

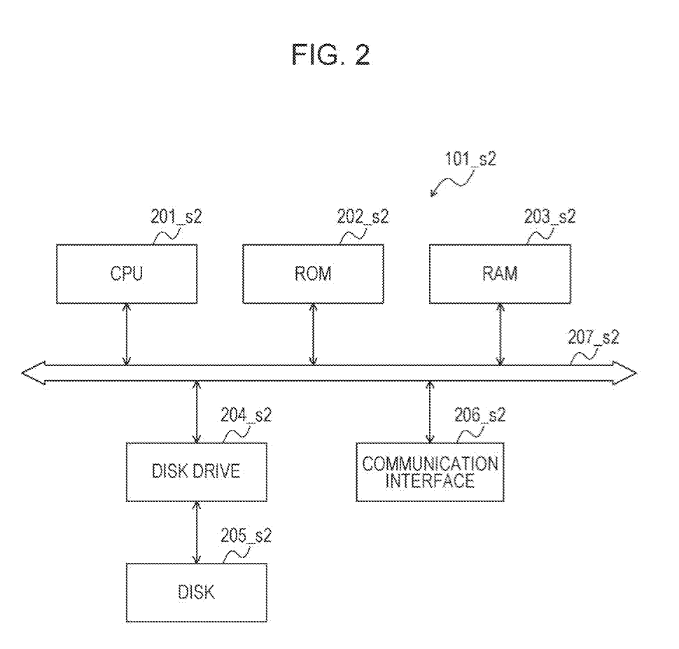

The information processing apparatus 101_s2 then obtains the combination 123 of the third volume and the fourth volume as indicated by (3) in FIG. 1B. The combination 123 is the OPC settings of the storage device 102_s2. As a result, the information processing apparatus 101_s2 is able to take over the OPC settings from the operations site s1 without the intervention of assistance when executing OPC using the copy control software 112_s2. Next, hardware of the information processing apparatus 101_s2 and the storage device 102_s2 will be explained with reference to FIGS. 2 and 3.

FIG. 2 is a block diagram of a hardware configuration of the information processing apparatus 101_s2. The information processing apparatuses 101_s1 and s2 have similar hardware configurations. The hardware of the information processing apparatus 101_s2 will be explained in FIG. 2 and the explanation of the hardware of the information processing apparatus 101_s1 will be omitted. The information processing apparatus 101_s2 in FIG. 2 has a central processing unit (CPU) 201_s2, a read only memory (ROM) 202_s2, and a random access memory (RAM) 203_s2. The information processing apparatus 101_s2 also includes a disk drive 204_s2, a disk 205_s2, and a communication interface 206_s2. The units from the CPU 201_s2 to the disk drive 204_s2 and the communication interface 206_s2 are connected to each other through a bus 207_s2.

The CPU 201_s2 is an arithmetic processor for controlling the entire information processing apparatus 101_s2. Moreover, an administration node may have a plurality of CPUs. The ROM 202_s2 is a non-volatile memory for storing programs such a boot program and the like. The RAM 203_s2 is a volatile memory used as a work area by the CPU 201_s2.

The disk drive 204_s2 is a control device for controlling reading and writing with respect to the disk 205_s2 according to the control by the CPU 201_s2. A magnetic disc drive, an optical disk drive, or a solid-state drive may be used, for example, as the disk drive 204_s2. The disk 205_s2 is a non-volatile memory for storing data written according to the control of the disk drive 204_s2.

For example, if the disk drive 204_s2 is a magnetic disc drive, a magnetic disc may be used for the disk 205_s2. Moreover, if the disk drive 204_s2 is an optical disk drive, an optical disk may be used for the disk 205_s2. Moreover, if the disk drive 204_s2 is a solid-state drive, a semiconductor memory formed by semiconductor elements, that is a semiconductor disk, may be used for the disk 205_s2.

The communication interface 206_s2 is a control device for governing an internal interface with a network and for controlling the input and output of data to and from another device. Specifically, the communication interface 206_s2 is connected to another device over the network through a communication line. For example, a modem or a local area network (LAN) adaptor may be used for the communication interface 206_s2.

Moreover, when an administrator of the information processing system 100 operates the information processing apparatus 101_s2 directly, the information processing apparatus 101_s2 may also have hardware such as a display, a keyboard, and a mouse.

FIG. 3 is a block diagram of a hardware configuration of the storage devices 102_s1 and s2. The storage devices 102_s1 and s2 have similar hardware configurations. The hardware of the storage device 102_s2 is explained in FIG. 3 and the hardware of the storage device 102_s1 is omitted. The storage device 102_s2 has a controller module (CM) 301_s2 and a plurality of volumes 302_s2.

The CM 301_s2 has a CPU 311_s2, a memory 312_s2, a channel adaptor (CA) 313_s2, a remote adaptor (RA) 314_s2, and fiber channels (FC) 315_s2.

The CM 301_s2 is a device for controlling the entire storage device 102_s2. Specifically, the CM 301_s2 controls the resource management of the plurality of volumes 302_s2, the memory 312_s2, and the CA 313_s2, and controls the OPC and REC copying.

The CPU 311_s2 is an arithmetic processor for controlling the entire storage device 102_s2. The memory 312_s2 may be a non-volatile memory for storing programs such as a boot program or may be a volatile memory that acts as a work area for the CPU 311_s2.

The CA 313_s2 is a control device for governing the interface with the information processing apparatus 101_s2. The RA 314_s2 is a control device for controlling the remote connection between the storage device 102_s1 and the storage device 102_s2. The FCs 315_s2 are control devices for governing the interfaces with the plurality of volumes 302_s2.

(Example of Functional Configuration of Information Processing Apparatus 101_s2)

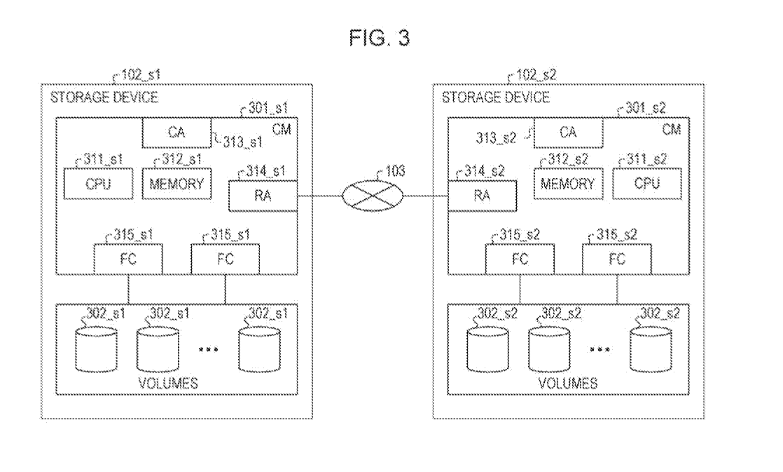

FIG. 4 is a block diagram of a functional configuration of the information processing apparatus 101_s2. The information processing apparatus 101_s2 has a control unit 400. The control unit 400 includes a transmitting unit 401 and an obtaining unit 402. The control unit 400 implements the functions of each unit due to the CPU 201_s2 executing programs stored in the storage devices. The storage devices are specifically the ROM 202_s2, the RAM 203_s2, the disk 205_s2, and the volumes of the storage device 102_s2 depicted in FIG. 2 for example. The processing results of each unit are stored in a register of the CPU 201_s2 or a cache memory or the RAM 203_s2 of the CPU 201_s2. While the control unit 400 is depicted in FIG. 4 as realizing the functions of the information processing apparatus 101_s2, the control unit 400 may also realize the functions of the information processing apparatus 101_s1.

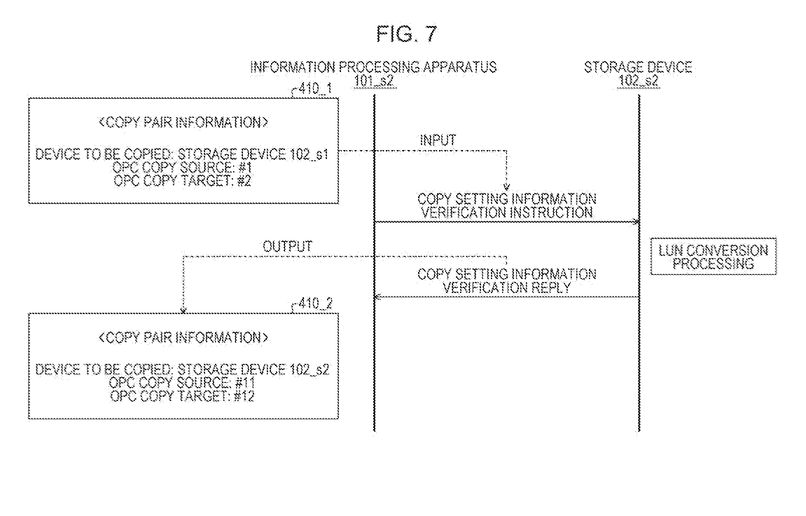

Moreover, the information processing apparatus 101_s2 is able to access copy pair information 410. The copy pair information 410 corresponds to the combination 121 depicted in FIG. 1B. Furthermore, the copy pair information 410 may be included in identification information of the storage devices 102 that are the objects of the copying. A detailed example of the copy pair information 410 is depicted in FIG. 7.

The transmitting unit 401 transmits the copy pair information 410 to the storage device 102_s2. A trigger for transmission may involve the transmitting unit 401 transmitting the copy pair information 410 to the storage device 102_s2 when, for example, the site performing the business service is switched to the disaster measures site s2 due to an operation by an administrator of the information processing system 100.

Further, the transmitting unit 401 may transmit the copy pair information 410 to the storage device 102_s2 in response to the virtual server v2 executed in the information processing apparatus 101_s1 as another information processing apparatus being transferred to the information processing apparatus 101_s2 as the host device. For example, the information processing apparatus 101_s2 monitors whether the virtual server v2 in the information processing apparatus 101_s1 is operating. The information processing apparatus 101_s2 then detects that the virtual server v2 in the information processing apparatus 101_s1 is shut down due to a disaster or the like. When the virtual server v2 in the information processing apparatus 101_s2 is restarted by using the data copied according to REC, the transmitting unit 401 transmits the copy pair information 410 to the storage device 102_s2 as if the transferred virtual server v2 has been transferred.

Further, the transmitting unit 401 determines that the identification information of the plurality of volumes in the storage device 102_s2 that recognizes the virtual server v2 after the virtual server v2 has been transferred, is different from the identification information of the plurality of volumes recognized by the virtual machine before the transfer of the virtual server v2. The identification information of the plurality of volumes recognized by the virtual machine before the transfer of the virtual server v2 is information that is copied from the storage device 102_s1 according to REC and obtained by the information processing apparatus 101_s2. The transmitting unit 401 may transmit the copy pair information 410 to the storage device 102_s2 if the identification information of the volumes recognized before and after the transfer of the virtual server v2 differs.

Using the example in FIG. 1B, the identification information of the plurality of volumes of the storage device 102_s2 recognized by the virtual server v2 after the transfer of the virtual server v2 indicates the LUNs of the volumes of the storage device 102_s2 which is LUN#10 to LUN#12. The identification information of the plurality of volumes recognized by the virtual server v2 before the transfer of the virtual server v2 indicates the LUNs of the volumes of the storage device 102_s1 which is LUN#0 to LUN#2. Therefore, because the identification information of the volumes recognized before and after the transfer of the virtual server v2 differs, the transmitting unit 401 transmits the copy pair information 410 to the storage device 102_s2.

The obtaining unit 402 obtains the copy pair information 410 after the conversion from the storage device 102_s2 that receives the copy pair information 410. A detailed example of the copy pair information 410 is depicted in FIG. 7.

(Example of Functional Configuration of Storage Device 102_s2)

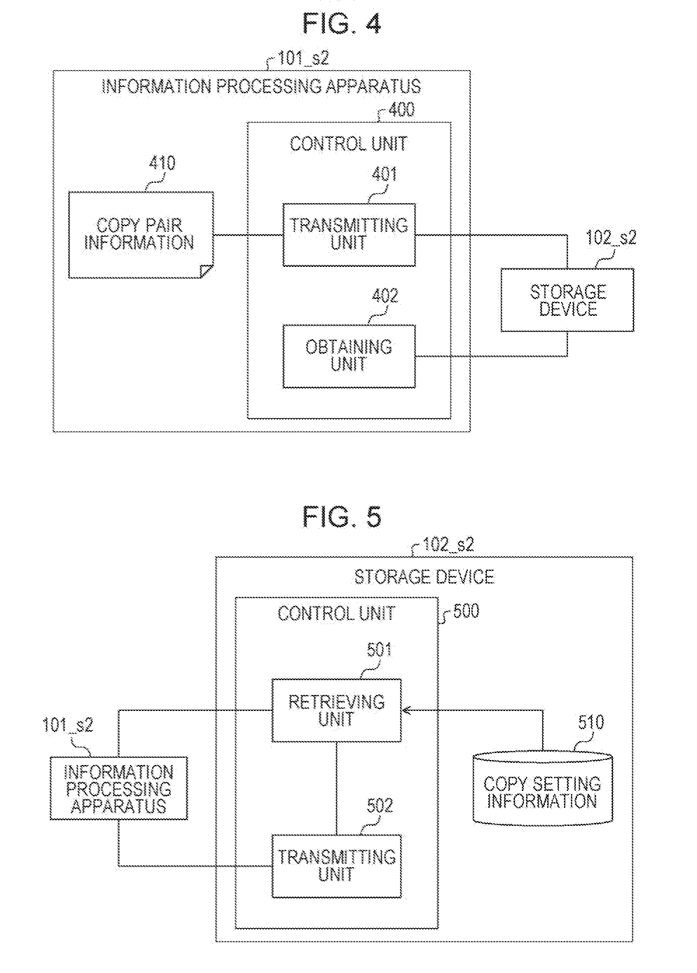

FIG. 5 is a block diagram of a functional configuration of the storage device 102_s2. The storage device 102_s2 has a control unit 500. The control unit 500 includes a retrieving unit 501 and a transmitting unit 502. The control unit 500 implements the functions of each unit due to the CPU 201_s2 executing programs stored in the storage devices. The storage devices are specifically the memory 312_s2 and the volume 302_s2 depicted in FIG. 3 for example. The processing result of the units are stored in a register of the CPU 311_s2, in a cache memory in the CPU 311_s2, or the memory 312_s2. The control unit 500 is depicted as a function of the storage device 102_s2 in FIG. 5, but may also be a function of the storage device 102_s1.

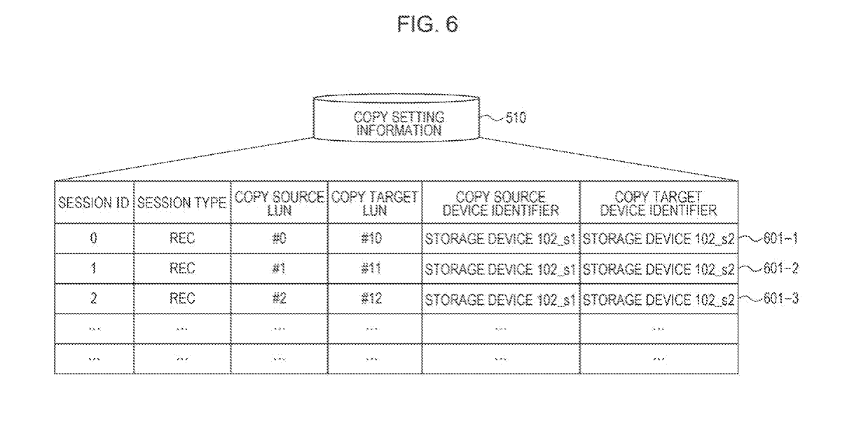

Moreover, the storage device 102_s2 is able to access copy setting information 510. The copy setting information 510 corresponds to the information 122 depicted in FIG. 1B. FIG. 6 is a view for explaining an example of stored contents of the copy setting information 510.

Upon receiving the copy pair information 410, the retrieving unit 501 refers to the copy setting information 510 and retrieves the third volume that is the data of the first volume copied according to REC among the plurality of volumes of the storage device 102_s2. The retrieving unit 501 retrieves the fourth volume that is the data of the second volume copied according to REC among the plurality of volumes of the storage device 102_s2.

The transmitting unit 502 transmits, to the information processing apparatus 101_s2, the copy pair information 410 after the conversion obtained from the combination of the third volume and the fourth volume detected by the retrieving unit 501. Further, the transmitting unit 502 may include the identification information of the storage device 102_s2 as the storage device that is the copy object in the copy pair information 410 after the conversion.

FIG. 6 is a view for explaining an example of stored contents of the copy setting information 510. The copy setting information 510 depicted in FIG. 6 has records 601-1 to 601-3. The copy setting information 510 includes fields for a session identifier (ID), a session type, a copy source LUN, a copy target LUN, a copy source device identifier, and a copy target device identifier.

The session ID field stores identification information for identifying a session. The session type field stores identification information for indicating the type of session. The copy source LUN filed stores an identification number of the volume that is the copy source. The copy target LUN filed stores an identification number of the volume that is the copy target. The copy source device identifier field stores identification information of the storage device affiliated with the volume that is the copy source. The copy target device identifier field stores identification information of the storage device affiliated with the volume that is the copy target.

For example in the record 601-1, the copy source device is indicated as the storage device 102_s1, the REC copy source LUN is indicated as the LUN#0, the copy target device is indicated as the storage device 102_s2, and the REC copy target LUN is indicated as the LUN#10.

FIG. 7 is a view for explaining an example of a conversion of the copy pair information 410. The information processing apparatus 101_s2 that executes the disaster measures software 111_s2 transmits a copy setting information verification instruction including each of the field values of the copy pair information 410 as input values, to the storage device 102_s2. Copy pair information 410_1 depicted in FIG. 7 indicates that the device to be copied is the storage device 102_s1, the OPC copy source is the LUN#1, and the OPC copy target is the LUN#2. The information processing apparatus 101_s2 transmits a copy setting information verification instruction including the respective identification information of the storage device 102_s1, the OPC copy source LUN#1, and the OPC copy target LUN#2, to the storage device 102_s2.

The storage device 102_s2 that receives the copy setting information verification instruction refers to the copy setting information 510 and performs LUN conversion processing. Specifically, the storage device 102_s2 retrieves, from the copy setting information 510, the REC session that has the REC copy source LUN having the same value as the OPC copy source included in the copy setting information verification instruction. Further, the storage device 102_s2 retrieves, from the copy setting information 510, the REC session that has the REC copy source LUN having the same value as the OPC copy target included in the copy setting information verification instruction.

When the copy setting information 510 depicted in FIG. 6 is used, the storage device 102_s2 retrieves the records 601-2 as the REC session having the REC copy source LUN with the same value as the OPC copy source. Similarly, the storage device 102_s2 retrieves the records 601-3 as the REC session having the REC copy source LUN with the same value as the OPC target source.

The storage device 102_s2 then transmits a copy setting information verification reply indicating the copy target device identifier and the REC copy target LUN of the detected REC session, to the information processing apparatus 101_s2. Using the abovementioned example, the storage device 102_s2 sets the copy target device identifier of the detected REC session to the storage device 102_s2 that is the copy target device identifier in the records 601-2 and 601-3. Further, the storage device 102_s2 sets the REC copy target LUN to the LUN#11 that is the REC copy target LUN in the record 601-2 and to the LUN#12 that is the REC copy target LUN in the record 601-3.

The information processing apparatus 101_s2 that receives the copy setting information verification reply uses the obtained copy setting information verification reply to convert the copy pair information 410. Copy pair information 410_2 depicted in FIG. 7 indicates that the device to be copied is the storage device 102_s2, the OPC copy source is the LUN#11, and the OPC copy target is the LUN#12.

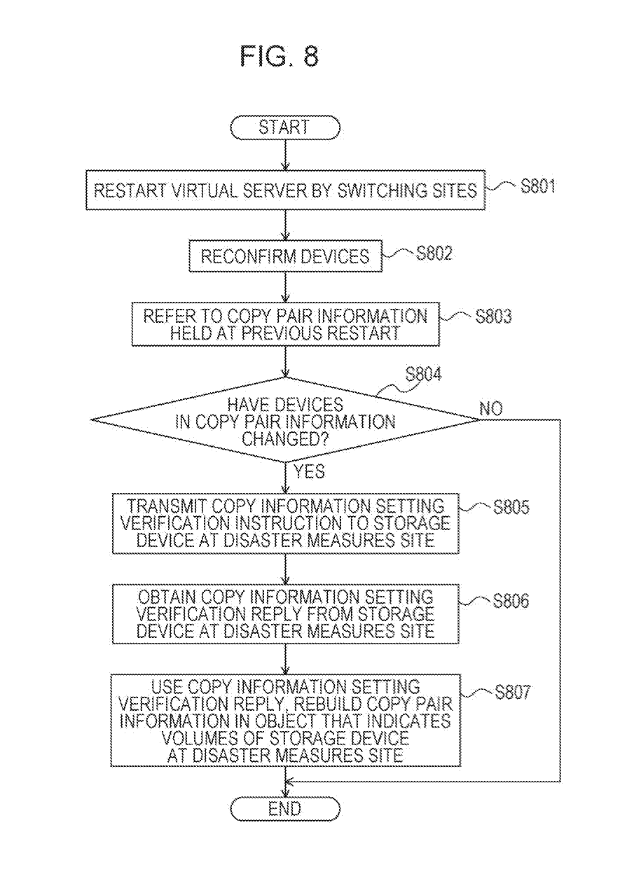

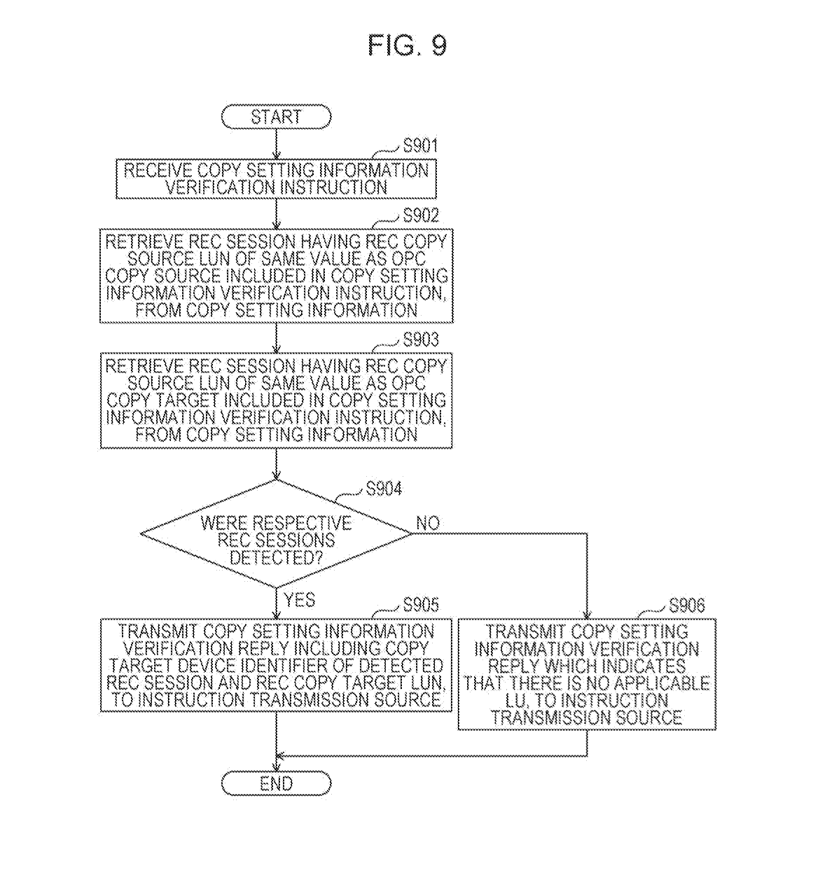

Next, a flow chart of the copy pair information conversion processing executed by the information processing apparatus 101_s2 will be explained using FIG. 8, and a flow chart of the LUN conversion processing executed by the storage device 102_s2 will be explained using FIG. 9.

FIG. 8 is a flow chart for illustrating an example of copy pair information conversion procedures after a site switch. The copy pair information conversion processing after a site switch is processing for converting the copy pair information 410.

The information processing apparatus 101_s2 restarts the virtual server v2 by switching sites using the disaster measures software 111_s2 (step S801). Next, the information processing apparatus 101_s2 reconfirms the devices using the copy control software 112_s2 (step S802). The information processing apparatus 101_s2 then refers to the copy pair information 410 held at the previous restart using the copy control software 112_s2 (step S803). Next, the information processing apparatus 101_s2 determines whether any of the devices in the copy pair information 410 have changed using the copy control software 112_s2 (step S804).

The method for determining in step S804 involves determining whether the identification information of the plurality of volumes recognized by the virtual server v2 after the transfer of the virtual server v2, is different from the identification information of the plurality of volumes recognized by the virtual machine before the transfer of the virtual server v2. If the identification information before and after the transfer is different, the information processing apparatus 101_s2 determines that the devices in the copy pair information 410 have been changed. If the identification information before and after the transfer is the same, the information processing apparatus 101_s2 determines that the devices in the copy pair information 410 have not been changed.

If the devices in the copy pair information 410 have changed (step S804: Yes), the information processing apparatus 101_s2 uses the copy control software 112_s2 to transmit the copy setting information verification instruction to the storage device 102_s2 at the disaster measures site s2 (step S805). The storage device 102_s2 that receives the copy setting information verification instruction executes the LUN conversion processing depicted in FIG. 9.

The information processing apparatus 101_s2 then obtains the copy setting information verification reply from the storage device 102_s2 at the disaster measures site s2 (step S806). The information processing apparatus 101_s2 then uses the copy control software 112_s2 to rebuild the copy pair information 410 to information that indicates the volumes of the storage device 102_s2 at the disaster measures site s2 by using the copy setting information verification reply (step S807).

After the conversion in step S807 is finished, or if the devices in the copy pair information 410 have not been changed (step S804: No), the information processing apparatus 101_s2 finishes the copy pair information conversion processing after switching the site. By executing the copy pair information conversion processing after switching the site, the information processing apparatus 101_s2 is able to convert the copy pair information 410 to the environment of the disaster measures site s2 after the switching of the site.

FIG. 9 is a flowchart of an example of LUN conversion procedures. The LUN conversion processing is processing for converting the LUNs. The storage device 102_s2 receives the copy setting information verification instruction (step S901). The storage device 102_s2 next retrieves, from the copy setting information 510, the REC session that has the REC copy source LUN with the same value as the OPC copy source included in the copy setting information verification instruction (step S902). The storage device 102_s2 further retrieves, from the copy setting information 510, the REC session that has the REC copy source LUN with the same value as the OPC copy target included in the copy setting information verification instruction (step S903).

The storage device 102_s2 then determines whether the respective REC sessions retrieved in steps S902 and S903 have been detected (step S904). If the respective REC sessions have been detected (step S904: Yes), the storage device 102_s2 transmits the copy setting information verification reply including the copy target device identifier and the REC copy target LUN from the detected REC session, to the instruction transmission source (step S905). However, if the respective REC sessions have not been detected (step S904: No), the storage device 102_s2 transmits a copy setting information verification reply which indicates that there is no applicable logical unit (LU), to the instruction transmission source (step S906).

After the processing of either step S905 or step S906 is finished, the storage device 102_s2 finishes the LUN conversion processing. By executing the LUN conversion processing, the storage device 102_s2 is able to convert the LUNs of the storage device 102_s1 to the LUNs corresponding to the storage device 102_s2.

As described above, the copy pair information 410 that is the OPC settings of the storage device 102_s1 is transmitted by the information processing apparatus 101_s2 to the storage device 102_s2 to obtain the copy pair information 410 that becomes the OPC settings of the storage device 102_s2. As a result, the information processing apparatus 101_s2 is able to use the REC setting contents and easily specify the OPC settings in the storage device 102_s2. The information processing apparatus 101_s2 furthermore is able to switch the copy pair information 410 from the operations site s1 to the disaster measures site s2 without carrying out settings due to the assistance of the administrator of the disaster measures site s2.

Further, the information processing apparatus 101_s2 may transmit the copy pair information 410 to the storage device 102_s2 in response to the virtual server v2 executed in the information processing apparatus 101_s1 being transferred to the information processing apparatus 101_s2. As a result, the information processing apparatus 101_s2 is able to switch the copy pair information 410 from the operations site s1 to the disaster measures site s2 in response to the detection of a disaster, and is able to quickly carry out the execution of OPC within the disaster measures site s2.

Moreover, the information processing apparatus 101_s2 may transmit the copy pair information 410 to the storage device 102_s2 when the identification information differs between the volumes recognized before and after the transfer of a virtual machine. Therefore, the information processing apparatus 101_s2 does not transmit the copy pair information 410 to the storage device 102_s2 if the LUN identification information of the operations site s1 and the disaster measures site s2 matches and the copy pair information 410 does not have to be converted. As a result, the information processing apparatus 101_s2 is able to limit the load applied to the disaster measures site s2.

While an explanation of the information processing system 100 including the operations site s1 and the disaster measures site s2 has been discussed in the above embodiment, the present embodiment is not limited in this way. For example, the embodiment discussed herein may be applied to an information processing system including the operations site s1 and a verification site for verifying the operations of the operations site s1. An information processing apparatus at the verification site executes the control method executed by the information processing apparatus 101_s2 whereby the information processing apparatus of the verification site is able to set the OPC settings of the verification site without assistance from an administrator of the verification site.

The control method executed by the information processing apparatus 101_s2 described in the present embodiment may be realized by executing a program prepared in advance using a computer such as a personal computer or a workstation. Furthermore, the control program may be recorded on a hard disk, a flexible disk, a compact disc-read only memory (CD-ROM), a digital versatile disk (DVD) or another type of computer-readable recording medium so that the control program may be executed by being read from the recording medium by the computer. The control program may also be distributed through a communication network such as the internet and the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus connected in an accessible manner to a second storage device in which data of volumes in a first storage device are duplicated due to a first duplication processing for duplicating data in volumes of a duplication source storage device to volumes in a duplication target storage device, wherein, the information processing apparatus has a control unit that:
transmits, to the second storage device, combination information for indicating a combination of a first volume that is a duplication source and a second volume that is a duplication target when a second duplication processing for duplicating data between volumes in a same storage device is executed by the first storage device; and
obtains, from the second storage device that received the combination information for indicating the combination of the first volume and the second volume, combination information for indicating a combination of a volume in which the data of the first volume is duplicated due to the first duplication processing and a volume in which data of the second volume is duplicated due to the first duplication processing, among a plurality of volumes of the second storage device.

2. The information processing apparatus according to claim 1 wherein,
the control unit:
transmits the combination information for indicating the combination of the first volume and the second volume to the second storage device, in response to a transfer of a virtual machine from another information processing apparatus connected in an accessible manner to the first storage device to the information processing apparatus connected in an accessible manner to the second storage device.

3. The information processing apparatus according to claim 2, wherein:
the control unit:
transmits, to the second storage device, the combination information for indicating the combination of the first volume and the second volume, when identification information of a plurality of volumes of the second storage device recognized by the virtual machine after the transfer of the virtual machine differs from identification information of a plurality of volumes recognized by the virtual machine before the transfer of the virtual machine.

4. An information processing system having a second storage device in which data of volumes in a first storage device are duplicated due to a first duplication processing for duplicating data in volumes of a duplication source storage device to volumes in a duplication target storage device, and an information processing apparatus connected in an accessible manner to the second storage device, wherein:
the information processing apparatus:
transmits, to the second storage device, combination information for indicating a combination of a first volume that is a duplication source and a second volume that is a duplication target when a second duplication processing for duplicating data between volumes in a same storage device is executed by the first storage device; and
obtains, from the second storage device that received the combination information for indicating the combination of the first volume and the second volume, combination information for indicating a combination of a third volume in which the data of the first volume is duplicated due to the first duplication processing and a fourth volume in which data of the second volume is duplicated due to the first duplication processing, among a plurality of volumes of the second storage device; and
the second storage device:
refers to information for indicating a combination of volumes of the first storage device and volumes of the second storage device in which data of the volumes is duplicated due to the first duplication processing and retrieves the third volume and the fourth volume when the combination information for indicating the combination of the first volume and the second volume is received; and
transmits the retrieved combination information for indicating the combination of the third volume and the fourth volume, to the information processing apparatus.

5. A non-transitory and computer-readable medium storing a control program for causing a computer, connected in an accessible manner to a second storage device in which data of volumes in a first storage device are duplicated due to a first duplication processing for duplicating data in volumes of a duplication source storage device to volumes in a duplication target storage device, to:
transmit, to the second storage device, combination information for indicating a combination of a first volume that is a duplication source and a second volume that is a duplication target when a second duplication processing for duplicating data between volumes in a same storage device is executed by the first storage device; and
obtain, from the second storage device that received the combination information for indicating the combination of the first volume and the second volume, combination information for indicating a combination of a volume in which the data of the first volume is duplicated due to the first duplication processing and a volume in which data of the second volume is duplicated due to the first duplication processing, among a plurality of volumes of the second storage device.
